(19) United States
(12) Patent Application Publication
(10) Pub. No.: US 2007/0013247 A1
(43) Pub. Date: Jan. 18, 2007

(54) COOLING FAN WITH DAMPING STRUCTURE SUPPORTING A SHAFT OF THE COOLING FAN

(76) Inventors: Chao-Nien Tung, Shenzhen (CN); Chuen-Shu Hou, Shenzhen (CN); Chih-Hao Yang, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/308,149

(22) Filed: Mar. 8, 2006

(30) Foreign Application Priority Data
Jul. 13, 2005 (CN) 200510035988.6

(51) Int. Cl. H02K 5/16; F04B 17/00; H02K 5/24

(52) U.S. Cl. 310/90; 417/423.12; 310/51

(57) ABSTRACT

A cooling fan includes a fan frame (10) having a central tube (12) defining a central hole (120) therein, a bearing (30) received in the central hole and a rotor (20) being rotatable with respect to the stator. The rotor includes a rotary shaft (24). A top end (240) of the shaft connects to a fan blade set. A free bottom end (242) of the shaft extends through the bearing into the central hole. A counter plate (40) made of high abrasion resistant material is located to face and supportively engage the free bottom end of the rotary shaft. A damping spring (70) exerts a force resiliently urging the counter plate against the free bottom end of the rotary shaft. The damping structure is capable of providing a cushion to a collision between the shaft and the bearing.

### FIELD OF THE INVENTION

The present invention relates generally to a cooling fan for electronic devices, and more particularly to a cooling fan having a damping structure supporting a shaft of the cooling fan so that an abrasion of the shaft and a corresponding bearing can be reduced and a life of the cooling fan can be extended.

### DESCRIPTION OF RELATED ART

To prevent an interior heat buildup which could potentially damage internal electronic operating components, various types of personal computers are typically provided with one or more internal cooling fans. While the computer is running, each fan normally operates to continuously draw ambient air into the computer housing structure through a housing air intake opening; the air is forced to flow through the electronic operating components to take the heat generated by the electronic operating component away therefrom. Finally, the heated air is discharged from the interior of the housing through a suitable air discharge opening formed therein.

A conventional cooling fan typically includes a frame having a central tube extending upwardly from a central portion thereof, a stator mounted around the central tube, a bearing supported by the central tube, and a rotor being rotatable with respect to the stator. The central tube defines a central hole for receiving the bearing therein. The rotor includes a fan blade set and a shaft extending downwardly from a central portion of the fan blade set. The shaft extends through the bearing into the central hole of the central tube. A counter plate made of high abrasion resistant material is received in a bottom end of the central tube to face and support a free bottom end of the shaft. There is a very small tolerance between the bearing and shaft. Moreover, a center of the rotor has a tendency to change its position since the position of the magnetic force of the stator interacting with the rotor is continuously varied. These factors bring the shaft of the rotor to repeatedly collide with and abrade the bearing, and the bearing or/and the shaft is/are easily to be damaged because of the collision and abrasion therebetween. Furthermore, the collision and abrasion can generate an undesirable vibration and noise, affecting the performance quality of the cooling fan.

Therefore, there is a need for a cooling fan which can reduce the abrasions and collision between the shaft and the bearing, thereby extending the useful life and reducing the vibration and noise of the cooling fan.

### SUMMARY OF INVENTION

According to a preferred embodiment of the present invention, a cooling fan comprises a fan frame having a central tube defining a central hole therein, a bearing received in the central hole and a rotor being rotatable with respect to the stator. The rotor includes a fan blade set and a rotary shaft extending downwardly therefrom. A top end of the shaft connects with the fan blade set. A free bottom end of the shaft opposite to the top end extends through the bearing into the central hole. A counter plate made of high abrasion resistant material is located to face and engage the free bottom end of the rotary shaft. A damping spring exerts a force resiliently urging the counter plate against the free bottom end of the rotary shaft. The damping structure is capable of lowering collision force and abrasions between the bearing and the shaft, thereby improving the quality and service life of the cooling fan.

Other advantages and novel features of the present invention will be drawn from the following detailed description of a preferred embodiment of the present invention with attached drawings, in which:

### BRIEF DESCRIPTION OF DRAWINGS

FIG. 1 is an assembled, cross-sectional view of a cooling fan in accordance with a preferred embodiment of the present invention.

FIG. 2 is similar to FIG. 1, but showing a second embodiment of the cooling fan;

FIG. 3 shows a third embodiment of the cooling fan;

FIG. 4 shows a forth embodiment of the cooling fan; and

FIG. 5 shows a fifth embodiment of the cooling fan.

### DETAILED DESCRIPTION

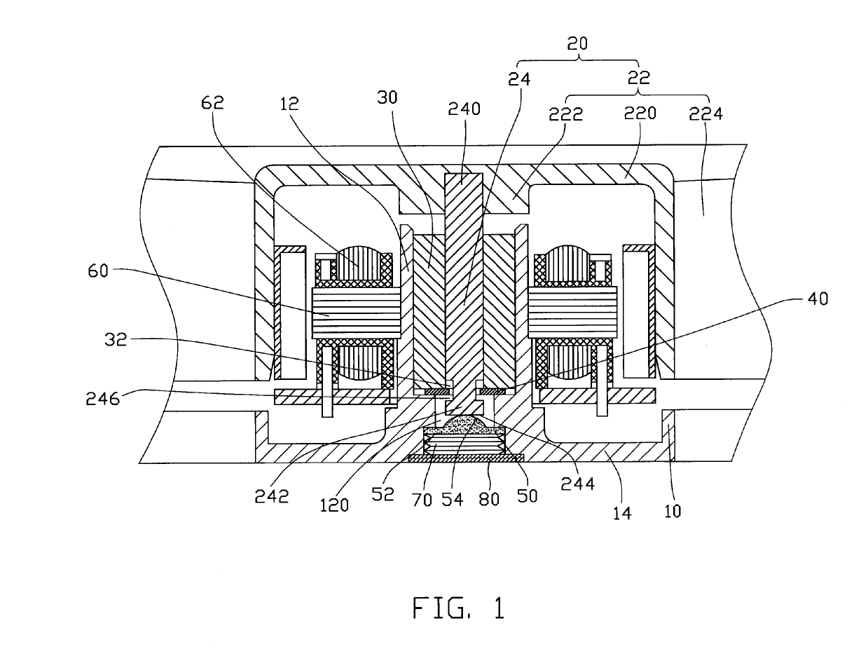

Referring to FIG. 1, a cooling fan with a damping structure according to a preferred embodiment of the present invention includes a frame 10 having a central tube 12 extending upwardly from a central portion thereof, a stator 60 mounted around the central tube 12, a bearing 30 received in the central tube 12, a rotor 20 being rotatable with respect to the stator 60, and a damping structure 70 received in a bottom of the central tube 12 for supporting the rotor 20 in balance.

The frame 10 includes a base 14 defining a circular hole in the central portion corresponding to the central tube 12. The central tube 12 defines a central hole 120 for receiving the bearing 30 therein. The central hole 120 communicates with the circular hole. A sealing cap 80 couples to the circular hole and seals a bottom end of the central tube 12.

The bearing 30 is mounted in the central hole 120 of the central tube 12, and the stator 60 includes windings 62 arranged around the central tube 12 to establish alternating magnetic field interacting with the magnetic field of the rotor 20 to drive the rotor 20 to rotate. A through hole 32 is defined in the bearing 30.

The rotor 20 includes a fan blade set 22 and a rotary shaft 24 extends downwardly from a central portion of the fan blade set 22. The fan blade set 22 includes a hub 220 forming a shaft seat 222 at a central portion thereof, and a plurality of fan blades 224 extending radially from an outer periphery of the hub 220. The shaft 24 has a top end 240 connects to the fan blade set 22, and a free bottom end 242 opposite to the top end 240. The free bottom end 242 of the shaft 24 extends through the through hole 32 of the bearing 30 into the central hole 120 of the central tube 12. A planar shaped bottom surface 244 is formed at the free bottom end 242 of the shaft 24 to face the damping structure 70. The damping structure 70 supportively engages with the bottom surface 244 of the shaft 24.

A circular groove 246 is defined in the shaft 24 near the free bottom end 242 of the shaft 24 corresponding to an bottom end of the bearing 30. A locking washer 40 is arranged in the central hole 120 and sandwiched between the bottom end of the bearing 30 and the central tube 12. The locking washer 40 has an inner diameter smaller than a diameter of the shaft 24, and an outer diameter larger than the diameter of the shaft 24. Thus the locking washer 40 is placed over the groove 246 of the shaft 24 to limit the movement of the shaft 24 along an axial direction thereof.

The damping structure 70 is arranged in the bottom end of the central hole 120 and locates on the sealing cap 80. In this embodiment, the damping structure 70 is a bellow-type air spring made of macromolecule material. The cooling fan further includes a counter plate 50 received in the central hole 120 and sandwiched between the bellow-type air spring 70 and free bottom end 242 of the shaft 24. The counter plate 50 is made of high abrasion resistant material, such as rubber. The counter plate 50 forms a plane-shaped lower surface 52 abutting against the bellow-type air spring 70, and an arc-shaped upper surface 54 abutting the bottom surface 244 of the free bottom end 242 of the shaft 24. Thus the bellow-type air spring 70 can exert a force resiliently urging the counter plate 50 against the free bottom end 242 of the shaft 24. The upper surface 54 of the counter plate 50 and the free bottom end 242 of the shaft 24 is in a point contact. A friction between the counter plate 50 and the shaft 24 is reduced.

When the cooling fan assembled together, the shaft 24 extends through the through hole 32 into the central hole 120 of the central tube 12. The counter plate 50 is sandwiched between the bottom surface 244 of the shaft 24 and the bellow-type air spring 70. The bellow-type air spring 70 is received in the bottom end of the central hole 120 and contacts the lower surface 52 of the counter plate 50. The bottom surface 244 of the shaft 24 abuts against a top point of the upper surface 54 of the counter plate 50. During operation, the rotor 20 is driven into rotate due to the interacting of the alternating magnetic field established by the stator 60 and the magnetic field of the rotor 20. By the provision of the damping structure 70, the force of collision and abrasion between the shaft 24 and the bearing 30 can be effectively reduced since the damping structure 70 provides a cushion to the collision. Furthermore, a friction (and accordingly abrasion) between the bottom surface 244 of the shaft 24 and the counter plate 50 is reduced since the damping member 70 can reduce a normal force acting by the shaft 24 on the counter plate 50, and the counter plate 50 has a reduced contact area with the bottom surface 244 of the shaft 24. Accordingly, the vibration and noise of the cooling fan during operation can be effectively lowered. The useful life of the cooling fan can be extended.

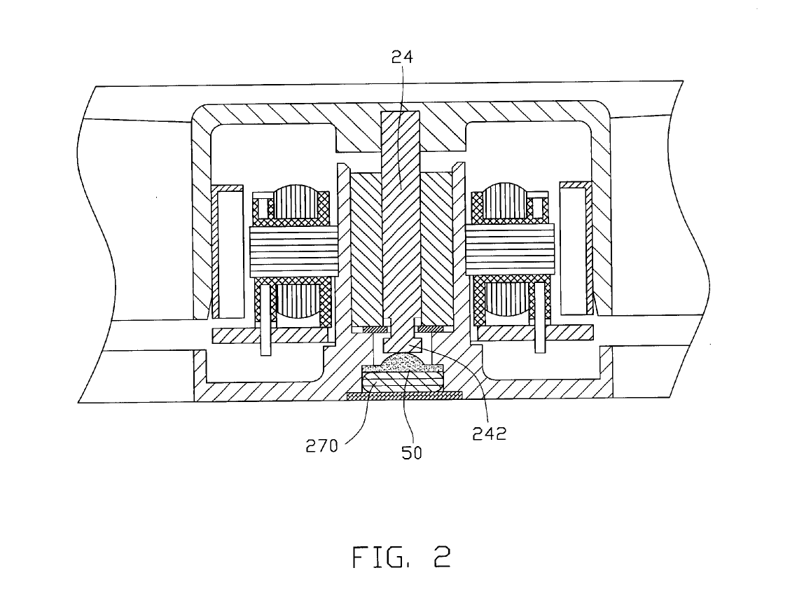

FIG. 2 illustrates the cooling fan in accordance with a second embodiment of the present invention. Except for the damping structure 270, other parts of the cooling fan in accordance with the second embodiment are substantially the same as the cooling fan of the previous embodiment. The damping structure 270 is a diaphragm-type air spring. Also the diaphragm-type air spring 270 is arranged below the counter plate 50 for exerting a force resiliently urging the counter plate 50 against the free bottom end 242 of the shaft 24. In these two embodiments the damping structures 70, 270 are air springs. In fact, a mechanical spring, for example, a coil spring, can also be adopted as the damping structure 70 (270) for exerting a force resiliently urging the counter plate 50 against the free bottom end 242 of the shaft 24.

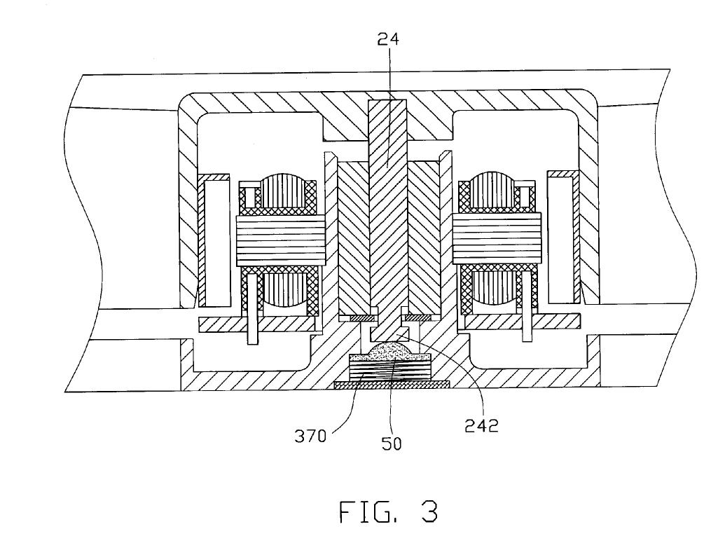

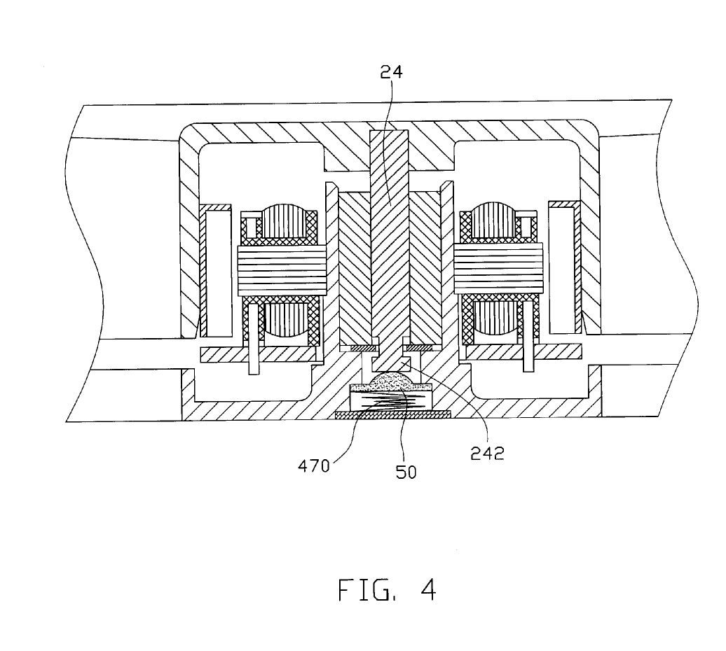

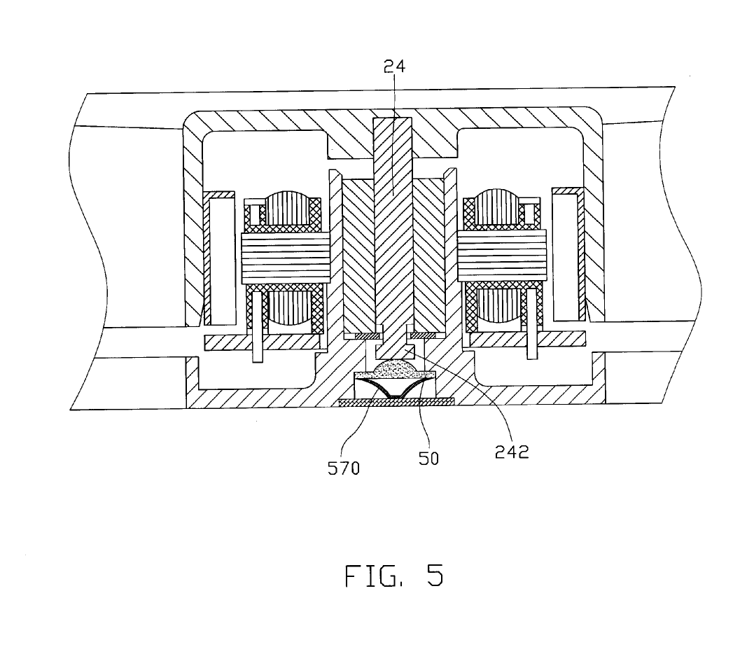

FIGS. 3-5 show the cooling fan of the present invention adopting mechanical springs. FIG. 3 shows a damping structure 370 in the form of a coil spring. The coil spring 370 can be made of macromolecule material, metal or metal alloy. FIG. 4 illustrates the cooling fan in accordance with a fourth embodiment of the present invention. In this embodiment the damping structure 470 is a planar spring. FIG. 5 shows the cooling fan having a leaf spring 570 as the damping structure for exerting a force resiliently urging the counter plate 50 against the free bottom end 242 of the shaft 24. Alternatively, the mechanical spring can be other forms, such as a conical spring. All the springs can be made of macromolecule material, metal or metal alloy.

It is understood that the invention may be embodied in other forms without departing from the spirit thereof. Thus, the present example and embodiment is to be considered in all respects as illustrative and not restrictive, and the invention is not to be limited to the details given herein.

What is claimed is:

1. A cooling fan comprising:
a frame having a central tube defining a central hole therein;
a bearing received in the central hole of the central tube;
a rotor comprising a fan blade set and a rotary shaft extending downwardly from the fan blade set through the bearing into the central hole;
a counter plate made of high abrasion resistant material located to face and supportively engage a free end of the rotary shaft; and
a damping spring exerting a force resiliently urging the counter plate against the free end of the rotary shaft.

2. The cooling fan as claimed in claim 1, wherein the damping spring is made of one of following material: macromolecule material, metal, metal alloy.

3. The cooling fan as claimed in claim 1, wherein the damping spring is an air spring.

4. The cooling fan as claimed in claim 3, wherein the air spring is one of a bellow-type air spring and a diaphragm-type air spring.

5. The cooling fan as claimed in claim 1, wherein the damping spring is a mechanical spring.

6. The cooling fan as claimed in claim 5, wherein the damping spring is selected from one of following springs: coil spring, planar spring, conical spring, leaf spring.

7. The cooling fan as claimed in claim 1, wherein the free end forms a planar shaped bottom surface, the counter plate forms an arc-shaped upper surface abutting against the bottom surface of the shaft.

8. The cooling fan as claimed in claim 1, wherein an annular groove is defined in the shaft near the free end thereof, a locking washer is received in the groove to limit the movement of the shaft along an axial direction thereof.

9. A cooling fan comprising:
a base having a central tube defining a central hole therein;
a bearing received in the central hole:
a rotary shaft extending through the bearing into the central hole;
an elastic member arranged at a free end of the shaft;
a counter plate made of high abrasion resistant material located between the free end of the shaft and the elastic member;
a stator surrounding the central tube; and
a rotor connecting with an end of the rotary shaft opposite the free end thereof and having a magnetic interaction with the stator.

10. The cooling fan as claimed in claim 9, wherein the elastic member is one of a bellow-type air spring and a diaphragm-type air spring.

11. The cooling fan as claimed in claim 9, wherein the elastic member is selected from one of following springs: coil spring, planar spring, conical spring, leaf spring.

12. The cooling fan as claimed in claim 9, wherein the free end forms a planar shaped bottom surface, the counter plate forms an arc-shaped outer surface abutting against the bottom surface of the shaft.

13. The cooling fan as claimed in claim 9, wherein an annular groove is defined in the shaft near the free end, a locking washer is received in the groove to limit the movement of the shaft along an axial direction thereof.

14. The cooling fan as claimed in claim 9, wherein the locking washer is located between the bottom end of the bearing and the central tube.

15. The cooling fan as claimed in claim 9, wherein elastic member is made of one of following material: macromolecule material, metal, metal alloy.

16. A cooling fan comprising:
a frame having a central tube with a bottom opening;
a stator mounted on the central tube;
a bearing mounted in the central tube;
a rotor having a magnetic interaction with the stator, comprising a shaft fitting through the bearing, a hub having a central portion fixedly connected with a top end of the shaft, and a plurality of fan blades extending radailly outwardly from the hub;
a cap sealing the bottom opening of the frame;
an elastic member mounted on the cap; and
a counter plate mounted on the elastic member and supportively engaging with a bottom end of the shaft.

17. The cooling fan as claimed in claim 16, wherein the counter plate has an arc-shaped surface engaging with the bottom end of the shaft.

18. The cooling fan as claimed in claim 17, wherein the elastic member is an air spring.

19. The cooling fan as claimed in claim 17, wherein the elastic member is a mechanical spring.

20. The cooling fan as claimed in claim 19 further comprising a washer engaging a lower portion of the shaft and sandwiched between the bearing and the frame to limit an axial movement of the shaft.
